(19) United States
(12) Patent Application Publication
(10) Pub. No.: US 2008/0271799 A1
(43) Pub. Date: Nov. 6, 2008

(54) Microfluidic Regulating Device

(75) Inventors: Reinhold Wimberger-Friedl, Veldhoven (NL); Rifat Ata Mustafa Hikmet, Eindhoven (NL); Ties Van Bommel, Horst (NL); Jacob Marinus Jan Den Toomder, Eindhoven (NL); Melike Yavuz, Istanbul (TR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/067,302

(22) PCT Filed: Sep. 19, 2006
(86) PCT No.: PCT/IB2006/053357

§ 371 Date: Mar. 19, 2008

(30) Foreign Application Priority Data
Sep. 20, 2005 (EP) 05108641.1

(51) Int. Cl. G05D 7/06; F15C 3/00; B01L 3/00

(52) U.S. Cl. 137/831; 137/827; 137/829; 435/286.5

(57) ABSTRACT

The invention relates to a microfluidic regulating device, comprising a first layer having a first microfluidic channel defined therein, a second layer having a second microfluidic channel defined therein, a fluid flow regulating layer disposed between the first and the second microfluidic channel, which layer comprises a movable valve member which in open position allows fluid communication between the first and second channel and in closed position seals against a valve seat, whereby at least part of the valve member and of the valve seat is magnetic. The device is able to store small quantities of liquids at microfluidic cartridges and access these on demand in a well controlled and simple way.

The invention relates to a microfluidic device having a movable valve member therein that may be used for the on-chip storage of reagents for bio sensing.

Microfluidic devices and in particular disposable microfluidic devices play an ever-increasing role in diagnostics with the growing interest in point-of-care diagnostics and integrated fast molecular diagnostics, which demand low-cost miniaturized solutions. Such microfluidic devices allow carrying out complicated biochemical reactions or analysis using very small volumes of sample fluid. For the analysis of biological sample fluids a number of steps typically have to be carried out, such as for instance pre-treatment of the liquid sample, mixing in of reagents, DNA amplification, specific binding to surfaces, washing steps, and so on. Some of these steps may employ auxiliary chemicals, which have to be transported through the microchannels of the device to particular areas of the device, typically on-chip areas, where reaction or analysis takes place. For a robust and convenient operation of such a device, apart from being able to redirect fluid flows, it would be highly desirable to be able to store chemicals and other fluids on the disposable device for prolonged periods of time. When needed for reaction or analysis, these chemicals would then be readily available.

A number of concepts have been proposed hitherto. In one known device, a wax plug is applied in the microfluidic channel to seal it off at least partly. The sealed part acts as storage container for a fluid. When the channel needs to be opened, the wax plug is melted by thermal resistance heating of electrodes positioned adjacent to the wax, and the fluid will eventually displace the melted wax plug. This approach is deficient in that the deformation of the wax is irreversible and, therefore, it can be used only once. Moreover, for good sealing the wax needs to be applied in a well-dosed quantity inside the microchannel before the device is provided with a cover, to which the wax must also adhere well. For good operation the fluid must be stored under pressure supplying the necessary force to displace the melted wax. Alternatively, membranes (thin sections in a channel) instead of wax have been proposed. To open a channel segment, the membranes are weakened by resistive heating and will eventually burst open under the pressure of the enclosed fluid. Debris formation is a regular problem and the operation of such a device is very sensitive to small variations in membrane thickness. In another known device a sealed reservoir is used, which is pinched with the aid of a sharp pin by a force exerted by an operator. This device is limited to relatively large storage volumes and channel dimensions. Integration in a microfluidics system is cumbersome and the fluid flow upon opening cannot be well controlled, since the shape of the pinched opening is irregular.

It is an object of the present invention to provide a device for storing small quantities of liquids at microfluidic cartridges and accessing it on demand in a well-controlled and simple way.

According to the invention this and other objects can be achieved by a microfluidic device, having the technical characteristics of claim 1. More in particular, the microfluidic device comprises a cover and a substrate, having defined therein at least a first and a second microfluidic channel, and a fluid flow regulating layer disposed between the cover and the substrate, whereby the fluid flow regulating layer comprises a movable valve member which in open position allows fluid communication between the first and second microfluidic channel and in closed position seals against a valve seat, whereby at least part of the valve member and of the valve seat is magnetic. The first and second microfluidic channel may be defined in the cover and substrate respectively. It is also possible according to the invention to both define the first and second microfluidic channel in either the cover or the substrate. The sealing of the valve member against the valve seat is achieved by the attractive magnetic forces between the two, whereby the sealing surfaces are preferably smooth and/or non-wetting surfaces. The valve member may be actuated by an electrical and/or electro-magnetic field to create an opening between valve member and seating through which the fluid can flow. Switching off or reversing the electrical and/or electro-magnetic field results in closure of the valve again under the action of the magnetic attractive forces. Leakage of stored chemicals is prevented by the action of the magnetic forces. Moreover, microfluidic devices are generally characterized by a large surface-to-volume ratio, which entails problems of potential permeation of solvents (typically water) through the walls of the containers. On the other hand, the fluids have to be readily available for analysis and/or reaction and therefore should be introducible in the microchannels on demand during the analysis of the sample fluids. These are clearly conflicting requirements, having to provide hermetic or about hermetic sealing during shelf life and instant access of the chemicals in a microfluidic environment with low-cost solutions. The device according to the invention solves all this in providing a tight closure of the container while the cartridge is stored and no power is available, and almost immediate availability of fluid flow upon request. An additional advantage is that the fluid will be able to flow at low pressure already and at a controlled rate.

The valve according to the invention may be closed hermetically or about hermetically in the powerless state and can be opened in a controlled and reversible way on demand. Not only does the valve not require any external power to keep it closed, it can be manufactured in a simple and low-cost way. In addition, by providing magnetic sealing surfaces, the device according to the invention does not need separate adhesives to seal the valve and valve seats. The use of adhesives is undesirable since these may interfere with the sample fluids. The device according to the invention allows to contain fluids for extended periods of time. This is not possible with prior art devices which typically rely on a pressure differential to open or close a valve or fluid flow regulating member in general. Such known devices need an external actuator to keep the fluid container closed. Devices which rely on a pressure differential between storage container and other parts of the microchannel system to sustain flow or open valves generally need venting gates to prevent drawing of vacuum in some parts of the microchannel system, thereby obviating flow. Venting gates, however, are undesirable since they create the possibility of leakage. The device according to the invention does not have this drawback.

In order to be able to communicate with the environment, the functional elements of the device, such as electronic chips and the like may typically be supported by and electrically connected to the substrate layer, which acts as interconnect to an instrument for read-out, for performing some operation, and/or otherwise. The electrical signals produced and/or received by the sensor and/or resulting from the interaction with the sample fluid, are transmitted through the interconnect substrate to auxiliary apparatus for further processing. The microfluidic channel system is defined between the facing surfaces of the substrate and the cover layer, provided for instance on top of the interconnect substrate. The device according to the invention provides the possibility of storing fluids for prolonged periods of time, without having to create ‘wet’ interfaces between instrument and disposable device, which is undesirable.

A further advantage of the device of the invention is that depending on the strength of the magnetic forces any closure force may be attained. Moreover, when providing multiple valves and seating members with different magnetic closing forces in the microfluidic channels, the channels may actually be opened successively by increasing the force of the external actuation locally, thus providing selective opening of valves in the device. The field maybe created locally by electrical conductors integrated in the interconnect substrate.

The term channel is meant to be interpreted broadly in the context of this application, and is not intended to be restricted to elongated configurations for instance. The channels may be cavities or tunnels of any desired shape, and a fluid cavity may comprise a flow-through cell where fluid is to be continually passed, or a chamber for holding a specific amount of fluid for some period. Although the invention is not limited thereto, microfluidic channels are typically meant to be understood as structures through which fluids are capable of flowing or in which fluids are contained, having dimensions of less than about 1 mm. In a microfluidic device the channels are typically provided in the cover and/or in the substrate. The channels are produced in a manner known per se, for instance by injection molding, by applying photolithography to define channels in silicon or glass substrates, or by etching techniques which remove material from the cover and/or substrate to form channels. The cover plate is usually bonded to the substrate to provide closure of the device.

When referring to the valve member and the valve seat as magnetic is meant in the context of this application that these may possess permanent magnetic properties or have induced magnetic properties. In an embodiment of the invention the microfluidic regulating device is characterized in that at least part of the valve member and of the valve seat is composed of a material with permanent magnetic susceptibility. In a preferred embodiment according to the invention the microfluidic regulating device is characterized in that at least part of the valve member and of the valve seat is permanently magnetic. In this way the storage time (also referred to as the shelf life) of the liquid may be extended. In the context of the application permanent magnetic materials are those involving molecules with permanent magnetic dipole moments. The valve member and seating may be made of, preferably permanent magnetic material, and/or may be provided with a magnetic coating. It is also possible to attach a discrete magnetic element to the movable valve member and/or the seating member through adhesive bonding or mechanical retention means.

The valve member may be made of rigid, semi-rigid and/or flexible material. In case a rigid valve member is employed, it may comprise a hinge region of a flexible material, or use a hinge region of rigid material with reduced thickness. Suitable materials can be chosen by one skilled in the art depending on the specific type of device used and the construction thereof, and may for instance comprise metal, paper, glass, polymer or combinations thereof. The valve may be made of highly elastic material, which allows the valve to open in a well controlled way, or the valve may be made of more flexible material to open up smoothly and possibly also according to different configurations. Suitable polymers include poyltetrafluoroethylene polymers (PTFE), polystyrenes (PS) or other vinylaromatic polymers, polypropylenes (PP), polyethylenes (PE) or other polyolefinic polymers, polyimides (PI), polyacrylates, polycarbonates, polyesters, thermoplastic elastomers, polyurethanes, rubbers, silicone rubbers and so on. Although not essential to the invention, these materials may be provided with an adhesive layer at one or both sides, if desired.

In another preferred embodiment according to the invention, the microfluidic regulating device is characterized in that the valve member and/or the seating is at least partly composed of a flexible substantially polymeric sheet. This embodiment improves the ease of fabrication of the device. Moreover, polymeric sheets generally are, or may readily be provided with a smooth and non-wetting surface, which further improves the closure of the valve member onto its seating. It should be understood that by substantially polymeric sheet is meant any sheet or foil, based on polymeric material, but eventually also comprising other additives, for instance mineral additives, and/or other materials, such as metal particles and/or flakes and/or foil, and the like. In order to be able to transmit electrical signals, the polymeric foil may also comprise conducting, for instance metallic, paths and/or interconnects.

It has advantages when the fluid flow regulating layer comprises an assembly of a first sheet disposed adjacent to the cover layer and a second sheet disposed adjacent to the substrate layer, the second sheet having an opening at second microfluidic channel height and comprising the valve seat, part of the first sheet being cut out so as to form the movable valve member at least partly covering the opening and sealing against at least part of the second sheet surface. This embodiment offers the possibility to readily provide the device with several openings and valve sections in one time. The sheets may be adhesively bonded onto each other or by other means, if desired. By providing an assembly of a first and second sheet, the valve seat properties can moreover be tailored independently of the material of the cover and substrate layer.

To provide this embodiment of the microfluidic regulating device with a movable valve, the first and second sheet in the assembly are substantially unbonded over at least part of the seating area. This allows a local movement of the first sheet with respect to the second sheet over at least this part of the seating area, whereby the size of the opening may be regulated depending on the size of the unbonded area. It has advantages to at least partly provide the first and/or the second sheet with a coating of a permanent magnetic material. More preferably the seating area of the first sheet is provided with a coating of a permanent magnetic material. It is also possible to provide the device according to the invention with first and/or second sheets composed of a permanently magnetic material.

In another preferred embodiment of the microfluidic regulating device according to the invention, the first and/or the second sheet are composed of a perforated sheet material. This allows for instance to slowly diffuse the fluid through the valve, even when in closed position, which may be advantageous in some circumstances.

In order to operate the microfluidic regulating device, it preferably further comprises an actuator for acting on the valve member. In this way an operator is able to manipulate the valve from a distance without interfering with the fluid flow. According to the invention several possibilities for actuation exist. In a preferred embodiment, the microfluidic regulating device is characterized in that the actuator comprises conduction paths applied over at least part of the movable valve member and of the valve seat, connected to a driver for supplying electric charge. In this embodiment it becomes possible to electrostatically charge valve member and seating. When the two sheets are poled oppositely the valve member will be repulsed, which will open the connection between first and second microfluidic channels. Upon reduction of the voltage the valve will gradually close, which offers the possibility of regulating the actual opening between the first and second microfluidic channel. Moreover, depending on the specific pattern wherein the conduction paths, i.e. the electrodes on the sheets, are applied, multiple valves may be addressed repeatedly.

In another preferred embodiment the actuator of the microfluidic regulating device comprises an electromagnet within actionable distance from the movable valve member. Upon switching on the magnet the movable valve will either be repulsed or attracted by the electromagnet and in this way open the channel. In a particularly preferred embodiment the electromagnet is included in the cover and/or substrate layer.

According to the invention, the device is not limited to providing a valve between two (segments of) microfluidic channels, but may also act as a cover for a reservoir or as a pump for moving fluids within the device. Also, several sensing and/or other functional elements may be integrated with different separate substrates on a single device to create a system usually referred to in the art as a lab-on-a-chip or micro-TAS.

In order to be able to define micro fluidic channels or a fluid introduction area on the assembly, from which the fluid interaction area may be replenished, the integrated functional element and interconnect assembly is preferably provided with a cover. Besides defining fluidic channels, the cover also acts as a closure to the system. The cover may be applied in any suitable manner, for instance by adhesive and/or thermal bonding.

The device according to the invention will now be described in more detail with reference to the embodiments shown in the accompanying figures, without however being limited thereto.

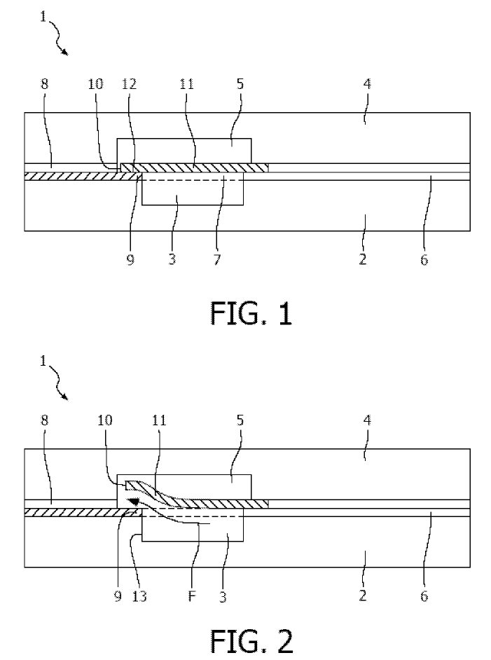

FIG. 1 schematically shows a side view in cross-section of a first embodiment of the device according to the invention;

FIG. 2 schematically shows a side view in cross-section of the embodiment of FIG. 1 in the open state;

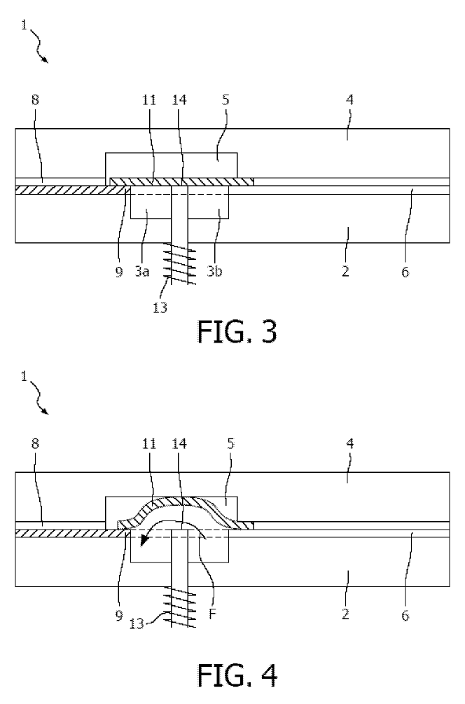

FIG. 3 schematically shows a side view in cross-section of another embodiment of the device according to the invention comprising an electromagnetic actuator;

FIG. 4 schematically shows a side view in cross-section of the embodiment of FIG. 3 in the actuated state;

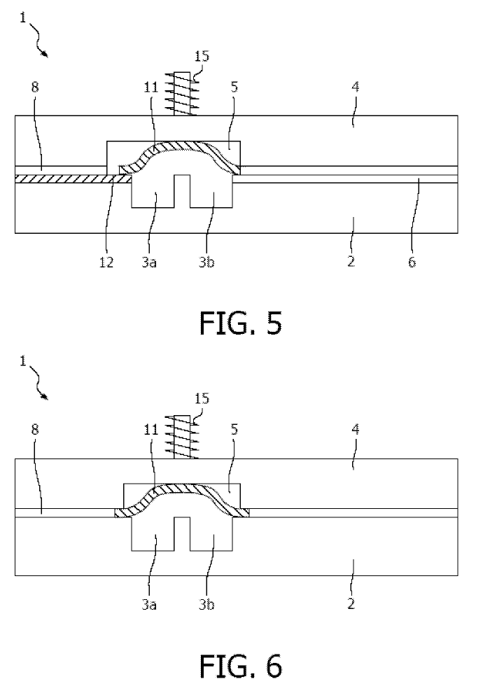

FIG. 5 schematically shows a side view in cross-section of another embodiment of the device according to the invention comprising an electromagnetic actuator;

FIG. 6 schematically shows a side view in cross-section of the embodiment of FIG. 5 in the actuated state.

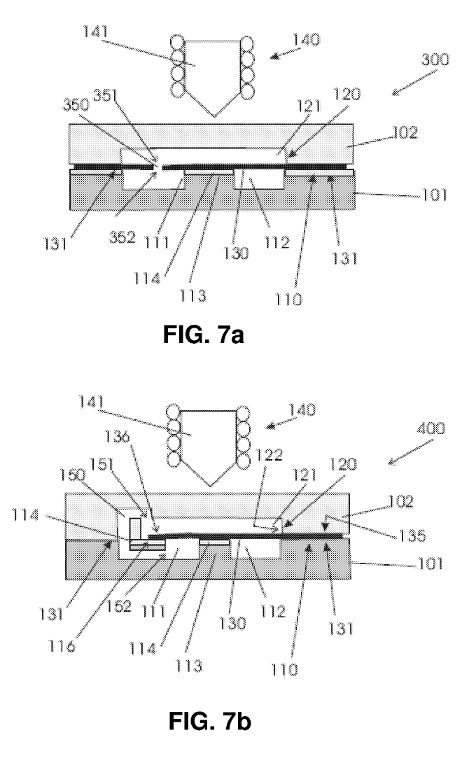

FIG. 7a and FIG. 7b is a schematic view of a microfluidic regulating device according to an embodiment of the present invention.

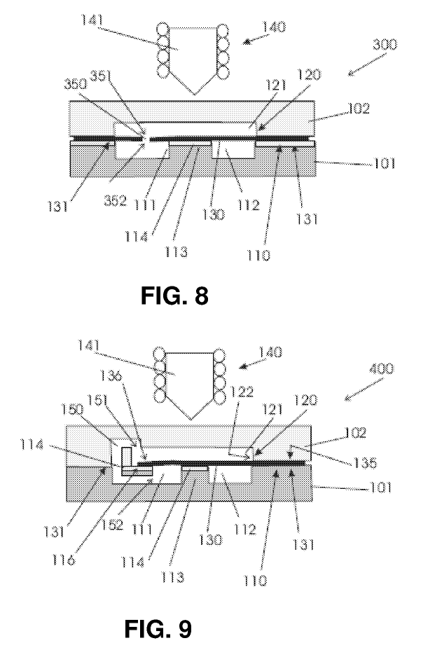

FIG. 8 and FIG. 9 are alternative microfluidic regulating devices according to embodiments of the present invention.

According to the invention, FIG. 1 shows a microfluidic system 1 comprising a second layer in the form of an electrical interconnect or back plate 2, containing at least one microchannel 3. The device is covered with a first layer or cover plate 4, containing at least one microchannel 5, positioned in relation to the back plate 2 such that fluid may flow from microchannel 4 to microchannel 5. On top of the back plate 2, a first sheet 6 is laminated which is structured in such a way that an opening 7 is created at the position where a valve is required, in other words where fluid flow from microchannel 3 to microchannel 5 should be made possible. The sheet 6 is coated in a patterned way or totally with a permanent magnetic material (indicated by the hatched area of sheet 6 in FIG. 1), or might alternatively be a composite material with permanent magnetic properties throughout. On top of sheet 6 another sheet 8 is laminated. Sheets 6 and 8 are adhesively bonded with a suitable adhesive, except in the area of the valve seating 9 in order to allow a local movement of the sheet 8 in this area. Again sheet 8 can either be coated locally or totally with a permanent magnetic layer or be a composite material with permanent magnetic properties (as indicated by the hatched area of sheet 8 in FIG. 1). Part of sheet 8 is cut along contour 10, thus defining a movable valve 11 in the form of a flap. Valve 11 is movable since it has a free end, defined by the unbonded surface area 12 and contour 10. In the case of electrostatic actuation the sheets 6 and 8 also contain conduction paths or electrodes, which are connected to a driver to apply electric charge (not shown). When the two sheets 6 and 8 are poled oppositely the top sheet 8 will be repulsed and the part of top sheet 8 which is free from second sheet 6, i.e. the valve 11 will be opened. Microchannels 3 and 5 are positioned such that upon actuation of the sheet 8 the fluid contained in microchannel 3 can pass through the gap between the sheet 11 and the chamber walls 13, as indicated in FIG. 2 by arrow F. When the voltage over the conduction paths is reduced, valve 11 will close again due to the magnetic attraction force between the hatched parts of sheet 8 and sheet 6. In this way it is also possible to address multiple valves repeatedly in a desired fashion by appropriately patterning the electrodes on the sheets 6 and 8.

In the case of electro-magnetic actuation an electromagnet 13 is positioned in the vicinity of the movable valve 11. Upon switching on the magnet 13 the permanent magnetic valve 11 will get either repulsed or attracted by the electromagnet 13 and in this way open the microchannel 3. In FIG. 3 an embodiment of a device is shown where the magnetic sheet 11 rests on a ridge 14 made of magnetic conductor material. When the external electromagnet 13 is switched on the magnet field lines emerging from the ridge 14 will push the sheet 11 away. In this way the channels 3a and 3b respectively left and right of the ridge 14 become connected, as schematically shown in FIG. 4, by arrow F. If desired the field direction can be switched to pull the valve 11 back to the ridge 14 which closes microchannel parts 3a and 3b again. The ridge 14 itself is stationary and sealed in the back plate 2. Another alternative embodiment with an external actuator 15 is schematically shown in FIG. 5.

Instead of a relatively stiff permanent magnetic sheet 8 a more elastic permanent magnetic sheet 8 can be used. In such an embodiment the microfluidic chamber 5 behind the valve 11 remains sealed all the time, even in the open state. This is illustrated in FIG. 6, where valve sheet 11 does not slide along the seating surface 12, as in the embodiment shown in FIG. 5, but instead is elongated during actuation.

The described embodiments of the device of the invention all have in common that they are of a simple construction comprising a back plate 2 and a cover plate 4, which can both be made by injection molding for instance, according to well known practice. In a preferred embodiment perforated sheet material with patterned permanent magnetic coating, optionally also provided with patterned electrodes, is used, which provides huge freedom of design, while the assembly basically becomes independent of the design. Such sheets can even be regular flex material, commonly used in electronic interconnects. In several cases a single sheet 8 may by sufficient, such as shown in the embodiment of FIG. 6. The stationary magnetic material can also be included in the backplane 2 by coating application or even by two-component molding, where one component is a permanent magnetic polymer composite.

Typically the sheet will comprise a polymer substrate (for instance polyimide, or polyester) with electrical wiring on it, which is covered by a thin insulating layer. On top of that a barrier coating can be applied, like parylene or inorganic materials or stacks of different materials. Locally a permanent magnetic coating is applied of sufficient magnetic strength to assure a perfect sealing even in case of possible pressure differences between the reservoir and the microchannels and also mechanical loads during transportation and handling. This coating can be applied by vacuum deposition through a mask and electrochemical deposition. At the surface of the sheet a soft and smooth coating can be applied to improve the contact between the sheet and the saddle if necessary. The surface can be treated by specific bio-compatibilizing materials and coatings, for instance to avoid fouling or other interferences with the reagents inside.

The assembly according to the invention may be used in a wide variety of applications, such as for instance as a general purpose sensor, a biosensor, environmental, food, health, and/or diagnostic sensor, lab-on-a-chip, integrated sample treatment and sensor assemblies, micro-TAS, and so on, for instance comprising heating and/or cooling elements which are particularly useful for DNA amplification (e.g. by PCR) and hybridization assays. Other suitable applications include for instance ICs with integrated electronic cooling, and LEDs or other compact light sources with integrated cooling.

In the description the term “channel” is to be understood broadly in the context of this application, and is not intended to be restricted to elongated configurations for instance. The channels may be cavities or tunnels of any desired shape. Channels may be flow-through channels or flow through cell where fluid is to be continually passed, or a chamber for holding a specific amount of fluid for some period. In a microfluidic device the channels are typically provided in a first and a second part, i.e. along a surface of the first part or the second part. The channels are produced in a manner known per se, for instance by injection moulding, by applying photolithography to define channels in silicon or glass parts, or by etching techniques which remove material from the surface of the part to form channels.

The term “microfluidic channels” are to be understood as channels through which fluids are capable of flowing or in which fluids are contained, having dimensions of preferably less than about 1 mm, such as less than 0.5 mm.

When referring to the moveable valve member and the valve seat as magnetic is meant in the context of this application that these may possess permanent magnetic properties or have induced or inducible magnetic properties. Magnetic material may have permanent magnetic susceptibility. In the context of the application, permanent magnetic materials are materials exhibiting a permanent magnetic field even when not influenced by an external magnetic field and which maintain this magnetic field even when placed in an external magnetic field. Such materials include molecules with permanent magnetic dipole moments.

By “substantially polymeric sheet” is meant any sheet or foil, based on polymeric material, but eventually also comprising other additives, for instance mineral additives, and/or other materials, such as metal particles and/or flakes and/or foil, magnetic powders or particles, and the like. In order to be able to transmit electrical signals, the polymeric foil may also comprise conducting, for instance metallic, paths and/or interconnects. Other arrangements for accomplishing the objectives of the microfluidic regulating device embodying the invention will be obvious for those skilled in the art. The substantially polymeric sheet may contain at least 30% polymeric material.

FIG. 7a and FIG. 7b show schematically a microfluidic regulating device 100 according to an embodiment of the present invention. FIG. 7a shows the microfluidic regulating device 100 in closed position, whereas FIG. 7b shows the microfluidic regulating device 100 in open position.

The microfluidic regulating device 100 comprises a first part 101 having a first part surface 110 and a second part 102 having a second part surface 120 facing the first part surface 110. The first part surface 110 comprises a first microfluidic channel 111, a second microfluidic channel 112 and a valve seat 113 positioned between the first channel 111 and the second channel 112. The second part surface 120 comprises a cavity 121 at height of the first channel 111, the second channel 112 and the valve seat 113. The microfluidic regulating device 100 further comprises a movable valve member 130. The movable valve member 130 is positioned between the first part surface 110 and the second part surface 120. In a first or closed position, the moveable valve member 130 is in fluid-tight contact with the first part surface 110 along a sealing line 131 encompassing the first channel 111, the second channel 112 and the valve seat 113. The microfluidic regulating device comprises an actuation means 140 to move the moveable valve member into an open position and into the closed position. To bring the moveable valve member 130 into the open position, the moveable valve member is moved into the cavity 121 thus allowing fluid communication between the first channel 111 and second channel 112. When the moveable valve member 130 is moved to its closed position, the moveable valve member is brought against the valve seat 113 for sealing the first channel 111 from the second channel 112. In this embodiment the microfluidic regulating device 100 further comprises a third channel 150 for equilibrating the pressure between the cavity 121 and the first microfluidic channel 111. The first channel is preferably used as inflow channel providing fluid to the device 100. The first part may be bonded to the second part to provide closure of the microfluidic regulating device by any suitable means, e.g. welding, adhesive, etc.

A third channel 150 is a conduit bypassing the movable valve member, having a first discharge 151 extending into the cavity and a second discharge 152 extending into the first microfluidic channel 111.

In the particular embodiment, the moveable valve member 130 is a membrane, preferably a substantially polymer membrane. The membrane is clamped between the first part 101 and the second part 102, more particular between the first part surface 110 and the second part surface 120. The first part 101 or bottom part, more particular the first part surface 110 contains the liquid inlet and outlet, whereas the second part 102 or top part, more particular the second part surface 120 contains a cavity 121 within which the membrane can be deformed.

According to this particular embodiment, the microfluidic regulating device 100 is activated based on electro-magnetic actuation, and that is relatively easy to fabricate.

The moveable valve member 130 is an elastic polymer membrane comprising dispersed magnetic powder, e.g. permanent magnetic powder, that is actuated using an electromagnet 141 and that can achieve large deflections. The moveable valve member 130 is fluidly impermeable. The powder may for example be hard magnetic powders, for example Barium ferrite, Strontium/Barium ferrite, Strontium ferrite, Aluminum-Nickel-Cobalt alloys, Samarium-Cobalt, or Neodymium-Iron-Boron powders. As an alternative, also dispersed superparamagnetic particles, for example iron oxide particles with radii smaller than 15 nm, may be used. The closed state of the moveable valve member is established using a magnetic film 114 providing the first part surface 111 of the first part 101. This has the advantage that no power is consumed to maintain the moveable valve member in the closed state. Another important aspect of the electromagnet design is that the actuation control is completely contactless, i.e. it is achieved without mechanical contact between actuation means 140 and the moveable valve member. The electromagnet 141 of the actuation means 140 is in actionable distance from the moveable valve member, i.e. the change in current provided to the solenoid of the electromagnet will make the moveable valve member move due to magnetic forces.

The moveable valve member thus comprises an elastic magnetic membrane on top of a magnetic, e.g. ferromagnetic material that is deposited on a first part 101, which contains the inlet channel, i.e. in this embodiment the first channel 111, as well as outlet channels for the liquid which in this embodiment are formed by the second channel 112.

The membrane may be provided with magnetic properties by incorporating magnetic, e.g. permanent magnetic particles in the polymer membrane, or the membrane may be coated with magnetic, e.g. permanent magnetic material.

The magnetic material on the first part 101 may be provided by a magnetic film 114, but may also be provided by providing a magnetic, e.g. ferromagnetic layer by coating, e.g. vacuum coating. Optionally, the first part is made out of magnetic, e.g. ferromagnetic material. The magnetic material of the first part 101 may be permanent magnetic material. The magnetic films on the first part surface is preferably a permanent ferromagnetic material such as CoNiMnP and CoCrTa. This can be deposited using physical vapor deposition or electroplating. It is important that at least the valve seat 113 is provided with magnetic material. Alternatively the magnetic element may be provided by two-component moulding, where one component is a magnetic polymer composite, such as a permanent magnetic polymer composite, or by insert moulding, where a magnetic material is inserted in the mold and overmolded by a plastic such as thermoplastic, thermoset or photoset material.

FIG. 7a shows schematically the basic working principle of the moveable valve member 130 in closed position, i.e. for the off-state position or the rest-mode of the magnetic membrane. When the moveable valve member 130 is closed, the only force acting on the member, i.e. the membrane, is the attraction force between the magnetic membrane and the magnetic material, e.g. ferromagnetic material of the first part. This avoids the passage of working fluid flow through the valve.

The on-state of the valve, i.e. the open position of the moveable valve member 130, is achieved using electromagnetic actuation with an electromagnet 141 e.g. a solenoid as illustrated in FIG. 7b. The total sum of the attraction force between the solenoid and the magnetic membrane will be larger than the magnetic attraction force between the magnetic membrane and the magnetic, e.g. ferromagnetic, material of the film 114 on the first part surface 110, so that the magnetic membrane will deflect upward into the cavity 121 and the process liquid can flow from the first channel 111, i.e. the inlet, to the second channel 112, i.e. the outlet.

The fluid pressure working on the lower side of the membrane, i.e. at the side facing to the first part surface is in equilibrium with the fluid pressure working on the second side of the membrane, i.e. the side facing the cavity 121. Hence, the fluid pressure does not affect the attraction force between the actuation means 140 and the moveable valve member 130.

The magnetic elastomeric membrane can, for example, be made using compression molding. The membrane should be magnetized in its thickness direction before application in the valve, which can be easily done using a large external magnetic field.

In this case, however, both sides of the membrane are accessible for the fluid. There is a connection in the form of a conduit, e.g. the third channel 150, between the inlet channel, i.e. the first channel 111, and the cavity, bypassing the membrane. This connection can be integrated in the first and second part as shown in FIG. 7a and FIG. 7b, but any other bypass could be used, e.g. it could also be established by simple tubing bypassing the complete moveable valve member. In the closed state the fluid cannot pass the membrane. There is no pressure drop across the membrane in the closed position, i.e. steady state. In the open position, i.e. in actuated state, the membrane can deflect as fluid in the cavity or chamber is pumped from the cavity back to the inlet, i.e. channel 111. The mechanical work of the membrane is only determined by the pressure drop across the bypass conduit, i.e. the third channel 150, between the cavity and the first channel, which scales with the viscosity of the fluid, the rate of displacement and the third channel dimensions. It is largely independent of the pressure of the fluid. The force balance on the membrane is affected by the size of the respective channels, i.e. the contact areas of the fluids with the membrane on the respective surfaces. Preferably, the expansion chamber of the membrane will have a larger contact area than the microfluidic inlet channel. In this way it is assured that the force exerted by a fluid at the inlet will be higher from the bypass side than from the inletchannel side. The valve will stay closed. The actuation force has to compensate at least that force difference. With increasing deflection the contact area from the inlet side will increase and consequently the net actuation force will increase. In dynamic state, there is local sealing force at the edges of the inlet channel, which is the result of the interaction with the seat and the membrane, such as the magnetic interaction between magnetic membrane and magnetic valve seat, plus the force exerted from fluid pressure in the cavity. The opening force is provided by the actuation operating on the membrane, such as a magnetic field from a magnetic or electromagnetic actuating means, plus the local fluid pressure in the inlet channel which in combination with the elastic properties of the membrane creates a peeling force that lifts off the membrane from the seat at the edges of the inlet channel. Once the lift off starts, the inlet pressure will provide more force because the contact area between the inlet fluid and the membrane will increase. Assuming that the pressure equilibration between cavity and inlet channel is perfect, the net fluid force on the membrane will be zero as soon as the valve is open and is not moving. Once the opening of the valve is initiated, the actuating force becomes independent from the fluid pressure, i.e. the actuating force is defined by the force necessary to deform the membrane and possibly to compensate other forces between membrane and valve seat, e.g. the magnetic attraction of valve seat and membrane, when a magnetic membrane and valve seat is used.

An advantage of this microfluidic regulating device, is that the fluid pressure, optionally the pressure of a liquid, on both side of the moveable valve member, in this case a membrane, are equal when the membrane does not move, i.e. p_{b}=pₜ. At the moment the membrane is actuated, a pressure difference will be established since the fluid will have to be pumped through the bypass conduit. This pressure difference can be reduced significantly, however, by making sure that the hydrodynamic resistance of the bypass conduit is very small, i.e. by making the conduit as short as possible whereas its cross section should be maximized. That means, that always p_{b}≅pₜ. The fluid pressure hence will play only a small role in the operation of the moveable valve member 150. In the case of a valve seat 113 and a moveable valve member being attracted to each other by magnetic forces, the forces necessary for actuation will be determined almost exclusively by the magnetic forces.

The fluid present in the cavity is not necessarily to be identical to the fluid being conducted through the microfluidic regulating device 100, i.e. the process fluid. However the process fluid and the fluid in the cavity are preferably immiscible. As an example, the fluid in the cavity is air, the process fluid being a liquid, immiscible with air. In this case, it is understood that the fluid impermeable moveable valve member is impermeable for air and the process liquid.

The process fluid entering at the inlet will not fill the ‘dead end’ third channel towards the backside of the membrane but rather compress the air in that part of the channel. The volume of the process fluid entering the third channel 150 will depend on the pressure of the process fluid and the volume of the third channel. Upon actuation of the moveable valve member 130, i.e. the membrane, moving into the cavity 121, part of the fluid in the cavity will be forced to flow into the third channel 150. The displaced volume, i.e. the volume difference of the cavity between open and closed position of the moveable valve member, of the membrane will be pumped back towards the inlet.

For certain applications the moveable valve member can be designed such that this displaced volume in the cavity by the moving valve member is smaller than the volume of process fluid entering the third channel to compress the air in the cavity to the process pressure. This in order to prevent the introduction of air in the main flow of the process fluid during switching of the moveable valve member. This may be obtained by making the volume V3 of the third ‘dead end’ channel larger, e.g. substantially larger than the displaced volume, displaced by the moveable valve member.

For certain applications it is important to reduce as much as possible the volume of process fluid remaining in the microfluidic regulating device. Ideally, no process fluid remains in the microfluidic regulating device. The remaining volume is also referred to as dead volume. In this case, this may be achieved by making the volume V3 of the third ‘dead end’ channel smaller than the displaced volume, displaced by the moveable valve member.

As an alternative to the concept shown in FIG. 7, the third channel may be connecting the second channel 112 and the cavity 121, instead of the first channel 111 and cavity 121.

In another embodiment the third channel or “bypass channel” is designed with a micro- or nanoporous barrier with hydrophobic surfaces. In this case process fluid such as liquid with a contact angle, Φ, higher than 90 deg cannot enter the third channel, while the pressure is still transduced via the fluid in the third channel and the cavity, which fluid may be air. In this way pressure levels up to the capillary pressure of the third channel can be resisted (Δp=σ cos Φ/h, with h the pore diameter of the microporous barrier), which can be up to about 1 bar.

Another microfluidic regulating device 300 according to an embodiment similar to FIG. 7 is schematically shown in FIG. 8. The microfluidic regulating device is in closed position. The same reference numbers refer to identical or similar features as for the microfluidic regulating device 100 of FIG. 7.

The microfluidic regulating device 300 has a third channel 350, i.e. an aperture extending or multiple apertures trough the movable valve member 130, having a first discharge 351 extending into the cavity 121 and a second discharge 352 extending into the first microfluidic channel 111. It is to be understood that in this particular embodiment the fluid in the cavity 121 will at least partially be provided by process fluid.

In order to have a sufficiently quick equilibration of the pressure in the first channel 111 and the cavity 121, the dimensions of the aperture are between 5 and 100 μm, whereas the dimensions of the first channel 111, second channel 112 and the cavity 121 are typically between 10 and 5000 μm.

Yet another embodiment of a microfluidic regulating device 400 is shown schematically in FIG. 9. The first part surface 110 has a border 116 encompassing the first channel 111 and the second channel 112. The moveable valve member 130 is a sheet having a clamped end 135 clamped along a part of the periphery 122 of the cavity 121, the sheet having a free end 136 making sliding contact with the border 116. The border is provided with magnetic properties, preferably made permanently magnetic. The free end is provided with magnetic properties as well to create a sealing of the free end to the border during sliding operation.

The magnetic material along the border 116 of the first part 101 may be provided by a magnetic film 114, but may also be provided by providing a magnetic, e.g. ferromagnetic layer, by coating, e.g. vacuum coating. Optionally, the first part is made out of magnetic, e.g. ferromagnetic material. The magnetic material of the first part 101 may be permanent magnetic material. The magnetic films on the first part surface is preferably a permanent ferromagnetic material such as CoNiMnP and CoCrTa. This can be deposited using physical vapour deposition or electroplating.

The free end 136 of the sheet of the moveable valve member 130 is provided with magnetic properties, preferably made permanently magnetic. This may be obtained by incorporating magnetic, e.g. permanent magnetic particles at least along the free end 136 of the sheet, or at least the free end of the sheet may be coated with magnetic, e.g. permanent magnetic material.

It is to be understood that although preferred embodiments, specific constructions and configurations, as well as materials, have been discussed herein for devices according to the present invention, various changes or modifications in form and detail may be made without departing from the scope and spirit of this invention. The embodiments described comprise magnetic moveable valve membranes and magnetic first part surfaces, and comprising electromagnetic actuating means. Alternatively, the electromagnetic fields to open or close the moveable valve member maybe created locally by electrical conductors integrated in the first and/or second part of the microfluidic regulating device.

However, it is to be understood that the same advantages may be obtained when other actuating means are used, which does not require magnetic moveable valve members and/or magnetic first part surfaces.

For the microfluidic regulating device 100 according to embodiments of the present invention comprising moveable valve members, valve seats and actuation means using magnetic properties to attract or to actuate the moveable valve member to move between open and closed position the sealing of the moveable valve member against the valve seat is achieved by the attractive magnetic forces between the two, whereby the sealing surfaces are preferably smooth and/or non-wetting surfaces. The moveable valve member may be actuated by an electrical and/or electro-magnetic field to create an opening between valve member and seating through which the fluid can flow. Switching off or reversing the electrical and/or electro-magnetic field results in closure of the valve again under the action of the magnetic attractive forces. The concept can be used to achieve a reservoir or container of process liquid, in which the fluid is kept by the closed valve that can be opened by one of the mentioned stimuli, i.e. electrical and/or electro-magnetic field. Leakage of stored chemicals out of the container is prevented by the action of the magnetic forces. Moreover, microfluidic devices are generally characterized by a large surface-to-volume ratio, which entails problems of potential permeation of solvents (typically water) through the walls of the containers comprising the microfluidic devices. On the other hand, the fluids have to be readily available for analysis and/or reaction and therefore should be introducible in the microfluidic channels on demand during the analysis of the process fluids. These are clearly conflicting requirements, having to provide hermetic or about hermetic sealing during shelf life and instant access of the chemicals in a microfluidic environment with low-cost solutions. The device according to the invention using magnetic properties of moveable valve members, valve seat and optionally actuating means solves all this in providing a tight closure of the container while the cartridge is stored and no power is available, and almost immediate availability of fluid flow upon request.

An additional advantage is that the fluid will be able to flow at low pressure already and at a controlled rate.

The device according to any of the embodiments of the present invention using magnetic properties of moveable valve members, valve seat and optionally actuating means may be closed hermetically or substantially hermetically in the powerless state and can be opened in a controlled and reversible way on demand. Not only does such a device not require any external power to keep it closed, it can be manufactured in a simple and low-cost way. In addition, by providing magnetic sealing surfaces, the device does not need separate adhesives to seal the valve and valve seats. The use of adhesives is undesirable since these may interfere with the process fluids. The device allows keeping fluids in the device for extended periods of time. This is to a less extent or even not possible with prior art devices which typically rely on a pressure differential to open or close a moveable valve member or fluid flow regulating member in general. Such known devices need an external means to keep the fluid container closed. Devices which rely on a pressure differential between storage container and other parts of the microchannel system to sustain flow or open valves generally need venting gates to prevent drawing of vacuum in some parts of the microchannel system, thereby obviating flow. Venting gates however are undesirable since they create the possibility for leakage. The device according to the invention does not have this drawback.

A further advantage of the device described is that any closure force with a maximum determined by the magnetic forces may be attained. Moreover, when providing multiple moveable valve members and accompanying valve seats with different magnetic closing forces in the microfluidic channels, the channels may actually be opened successively by increasing the force of the external actuation locally, thus providing selective opening of moveable valve members in the microfluidic regulating device. The field maybe created locally by electrical conductors integrated in the first and/or second part of the microfluidic regulating device.

The microfluidic regulating device as subject of the present invention may be used in e.g. microfluidic systems. For example in biotechnological applications such as biosensors, rapid DNA separation and sizing, cell manipulation and sorting, in pharmaceutical applications, in particular high-throughput combinatorial testing where local mixing is essential, and in microchannel cooling systems in microelectronics applications.

1. Microfluidic regulating device, comprising a cover layer and a substrate layer, having defined therein at least a first and a second microfluidic channel, further comprising a fluid flow regulating layer, which layer comprises a movable valve member which in open position allows fluid communication between the first and second channel and in closed position seals against a valve seat, characterized in that at least part of the valve member and of the valve seat is magnetic.

2. Microfluidic regulating device according to claim 1, characterized in that at least part of the valve member and of the valve seat is permanently magnetic.

3. Microfluidic regulating device according to claim 1, characterized in that at least part of the valve member and of the valve seat is composed of a material with permanent magnetic susceptibility.

4. Microfluidic regulating device according to claim 1, characterized in that the valve member and/or the valve seat are at least partly composed of a flexible polymeric sheet.

5. Microfluidic regulating device according to claim 1, characterized in that the fluid flow regulating layer comprises an assembly of a first sheet and a second sheet, the first sheet having an opening at first microfluidic channel height and comprising the valve seat, part of the second sheet being cut out so as to form the movable valve member at least partly covering the opening and sealing against at least part of the first sheet surface.

6. Microfluidic regulating device according to claim 5, characterized in that in the assembly the first and the second sheet are substantially unbonded over at least part of the seating area.

7. Microfluidic regulating device according to claim 1, characterized in that the first and/or the second sheet are at least partly provided with a coating of a permanent magnetic material.

8. Microfluidic regulating device according to claim 7, characterized in that the seating area of the first sheet is provided with a coating of a permanent magnetic material only.

9. Microfluidic regulating device according to claim 1, characterized in that the first and/or the second sheet are composed of a permanently magnetic material.

10. Microfluidic regulating device according to claim 1 characterized in that the first and/or the second sheet are composed of a perforated sheet material.

11. Microfluidic regulating device according to claim 1, characterized in that the device further comprises an actuator for acting on the valve member.

12. Microfluidic regulating device according to claim 11, characterized in that the actuator comprises conduction paths applied over at least part of the movable valve member and of the valve seat, connected to a driver for supplying electric charge.

13. Microfluidic regulating device according to claim 11, characterized in that the actuator comprises an electromagnet within actionable distance from the movable valve member.

14. Microfluidic regulating device according to claim 12, characterized in that the electromagnet is part of the first or second layer.

15. Microfluidic regulating device according to claim 1, further comprising a third channel for equilibrating the pressure between the cavity and the first microfluidic channel.

16. Microfluidic regulating device according to claim 1, wherein the first part surface has a border encompassing the first channel and the second channel, the moveable valve member is a sheet having a clamped end clamped along a part of the periphery of the cavity, the sheet having a free end making sliding contact with the border, the border and the free end having magnetic properties for sealing the free end to the border during sliding.

17. Microfluidic regulating device according to claim 1, wherein the third channel is provided by means of at least one aperture extending trough the movable valve member, having a first discharge extending in the cavity and a second discharge extending in the first microfluidic channel.

18. Microfluidic regulating device according to claim 1, wherein the third channel is a conduit bypassing the movable valve member, having a first discharge extending in the cavity and a second discharge extending in the first microfluidic channel.

19. Microfluidic regulating device according to claim 1, wherein the third channel has a volume V3, the volume displaced in the cavity by moving the moveable valve member between open and closed position being smaller than or equal to the volume V3.

20. Microfluidic regulating device according to claim 1, wherein the third channel has a volume V3, the volume displaced in the cavity by moving the moveable valve member between open and closed position being larger than or equal to the volume V3.

21. Microfluidic regulating device according to claim 1, wherein the third channel is provided with a micro- or nanoporous barrier having a hydrophobic surface.

22. Microfluidic regulating device according to claim 1, wherein at least part of the moveable valve member comprises magnetic material, the actuating means comprises an electromagnet within actionable distance from the movable valve member.

23. Microfluidic regulating device according to claim 1, wherein the movable valve member is a fluid impermeable moveable valve member.

24. Sensor comprising a microfluidic regulating device according to claim 1.
